(19) United States
(12) Patent Application Publication
(10) Pub. No.: US 2019/0299262 A1
(43) Pub. Date: Oct. 3, 2019

(54) WASHING DEVICE AND OPERATION SETTING METHOD THEREOF

(71) Applicant: SHIBUYA MACHINERY CO., LTD., Kanazawa-shi (JP)

(72) Inventors: Masahiro DAIJO, Kanazawa-shi (JP); Takahito KITAMURA, Kanazawa-shi (JP)

(21) Appl. No.: 16/357,947

(22) Filed: Mar. 19, 2019

(30) Foreign Application Priority Data
Mar. 29, 2018 (JP) 2018-064912

(51) Int. Cl. B08B 9/045; B05B 3/02; B08B 3/02; B08B 1/04

(52) U.S. Cl. CPC B08B 9/045; B05B 3/025; B05B 1/04; B08B 1/04; B08B 3/02

(57) ABSTRACT

A washing device 1 includes an inner tube 13 pivotally supported rotatably, a turning shaft 14 provided in a direction substantially orthogonal to the inner tube 13 and pivotally supported rotatably at a distal end of the inner tube 13, and a nozzle 3 provided on the turning shaft 14, and the nozzle 3 is rotated in a revolving direction and in a rotating direction by a first motor 25 and a second motor 28.
A revolving direction model 41a for setting an operation of the nozzle 3 in the revolving direction and a rotating direction model 41b for setting the operation of the nozzle in the rotating direction are displayed on display means 7, and a movement locus of the nozzle is prepared from the set operations of the nozzle in the revolving direction and in the rotating direction.

### BACKGROUND OF THE INVENTION

### Field of the Invention

The present invention relates to a washing device and an operation setting method thereof and, in more detail, relates to a washing device which moves a nozzle on a three-dimensional movement locus and performs washing and the operation setting method thereof.

### Description of the Related Art

Conventionally, a washing device for washing an inner surface of a tank by making a nozzle enter an inside of an object to be washed in which a cavity is formed such as a tank is known, and as such washing devices, the one which injects a washing liquid to the entire inner surface of the tank by moving the nozzle on a three-dimensional movement locus is known (Japanese Patent No. 4636956).

The washing device of the aforementioned Japanese Patent No. 4636956 includes a rotation shaft and a turning shaft provided at a distal end of the rotation shaft and provided in a direction orthogonal to the rotation shaft, and the nozzle is provided on the turning shaft so that the nozzle is moved three-dimensionally.

### SUMMARY OF THE INVENTION

The washing device of the aforementioned Japanese Patent No. 4636956 is configured to drive the nozzle by one motor, and more specifically, the rotation shaft and the turning shaft are rotated in conjunction when the rotation shaft is rotated by the motor by providing a pair of bevel gears on the rotation shaft and the turning shaft.

Thus, the nozzle is revolved around the rotation shaft and is turned around the turning shaft with a constant pattern, and since the movement locus of the nozzle is made constant, one spot cannot be washed with emphasis.

Thus, if there is a heavily stained spot or a spot difficult to be washed, washing time needs to be prolonged or the number of washing times needs to be increased, which increases a cost for washing, and washing efficiency is poor, which are problems.

For such problems, the movement locus of the nozzle can be controlled arbitrarily by individually controlling rotations of the rotation shaft and the turning shaft by using two motors.

However, since the movement locus of the nozzle in this case is determined by parameters of rotation speeds of the two motors and the number of gear teeth and the like, setting and adjustment of a desired washing locus by inputting these parameters have been a burden on a worker.

In view of these problems, the present invention provides a washing device which can visually set the three-dimensional movement locus of the nozzle by a worker using a displayed model and an operation setting method thereof.

That is, the operation setting method of the washing device according to claim 1 is an operation setting method of a washing device including a rotation shaft having a washing liquid passage provided therein and pivotally supported rotatably, a turning shaft provided in a direction substantially orthogonal to the rotation shaft and pivotally supported rotatably at a distal end of the rotation shaft, a nozzle provided on the turning shaft and injecting the washing liquid, a first motor and a second motor for rotating the rotation shaft and the turning shaft so as to rotate the nozzle around the rotation shaft and the turning shaft, and control means for controlling movement of the nozzle by controlling the first motor and the second motor, respectively, characterized by including:

a display step of displaying a first rotation model for setting an operation of the nozzle around the rotation shaft and a second rotation model for setting the operation of the nozzle around the turning shaft;

a setting step of setting the operation of the nozzle around the rotation shaft and the operation of the nozzle around the turning shaft by using the displayed first rotation model and second rotation model; and

a preparation step of preparing a movement locus of the nozzle from the set operation of the nozzle around the rotation shaft and operation of the nozzle around the turning shaft.

Moreover, the washing device according to claim 3 is a washing device including a rotation shaft having a washing liquid passage provided therein and pivotally supported rotatably, a turning shaft provided in a direction substantially orthogonal to the rotation shaft and pivotally supported rotatably at a distal end of the rotation shaft, a nozzle provided on the turning shaft and injecting the washing liquid, a first motor and a second motor for rotating the rotation shaft and the turning shaft so as to rotate the nozzle around the rotation shaft and the turning shaft, and control means for controlling movement of the nozzle by controlling the first motor and the second motor, respectively, characterized by including:

display means for displaying a first rotation model for setting an operation of the nozzle around the rotation shaft and a second rotation model for setting the operation of the nozzle around the turning shaft; and

a movement locus of the nozzle is set on the basis of the operation of the nozzle around the rotation shaft and the operation of the nozzle around the turning shaft set by the first rotation model and the second rotation model.

According to the present invention, by using the first rotation model for setting the operation of the nozzle around the rotation shaft and the second rotation model for setting the operation of the nozzle around the turning shaft, the worker can set a three-dimensional movement locus of the nozzle while visually imaging a direction of the nozzle without necessity of setting parameters such as the rotation speed of the motor by considering the number of gear teeth.

After that, the movement locus of the nozzle is automatically set on the basis of the operation of the nozzle around the rotation shaft and the operation around the turning shaft selected in the first rotation model and the second rotation model.

### BRIEF DESCRIPTION OF THE DRAWINGS

FIG. 1 is a sectional view of a washing device according to an embodiment;

FIG. 2 is an operation explanatory view illustrating a movement locus of a nozzle;

FIG. 3 is a view for explaining a nozzle and a revolving direction as well as a rotating direction;

FIG. 4 is a view illustrating a movement locus setting portion and a work pattern setting portion displayed on display means; and

FIG. 5 is a view illustrating a revolving direction model and a rotating direction model and the set movement locus of the nozzle.

### DETAILED DESCRIPTION OF THE PREFERRED EMBODIMENTS

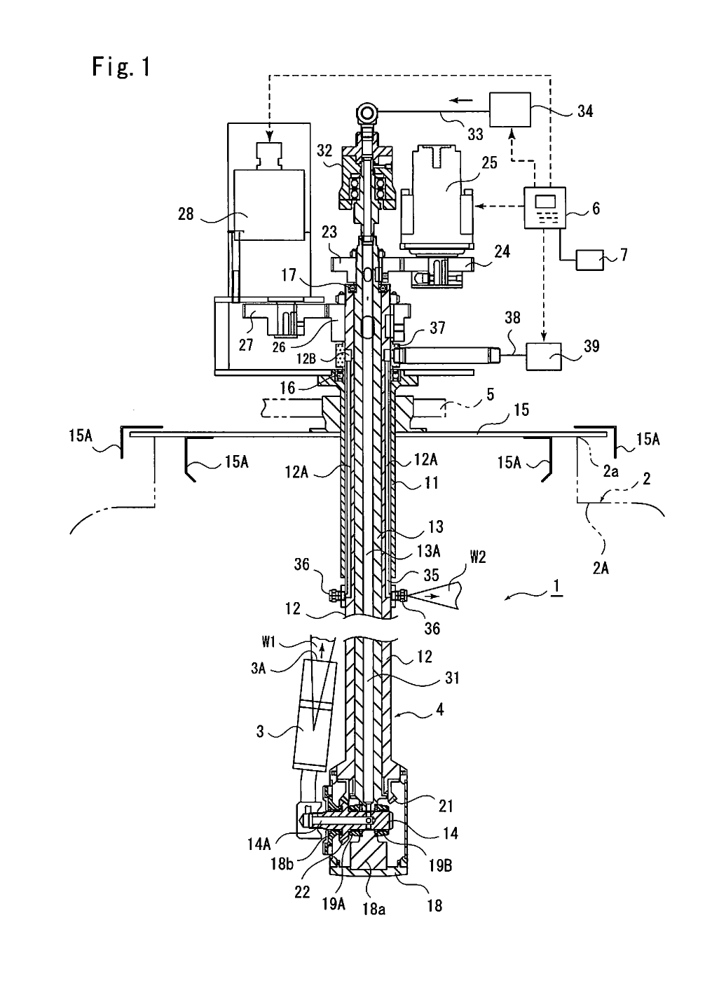

Hereinafter, the present invention will be described by referring to an illustrated embodiment, in which FIGS. 1 to 3 illustrate a washing device 1 for washing an inner surface 2A of a tank 2 as an object to be washed, and this washing device 1 includes a washing unit 4 for injecting a washing liquid such as water from a nozzle 3 toward the inner surface 2A of the tank 2 and an elevating mechanism 5 for elevating the washing unit 4 up/down.

According to the washing device 1 having the constitution above, when the elevating mechanism 5 elevates the washing unit 4 up/down and positions the nozzle 3 inside the tank 2, it causes the washing liquid to be injected from the nozzle 3 so as to wash the inner surface 2A of the tank 2.

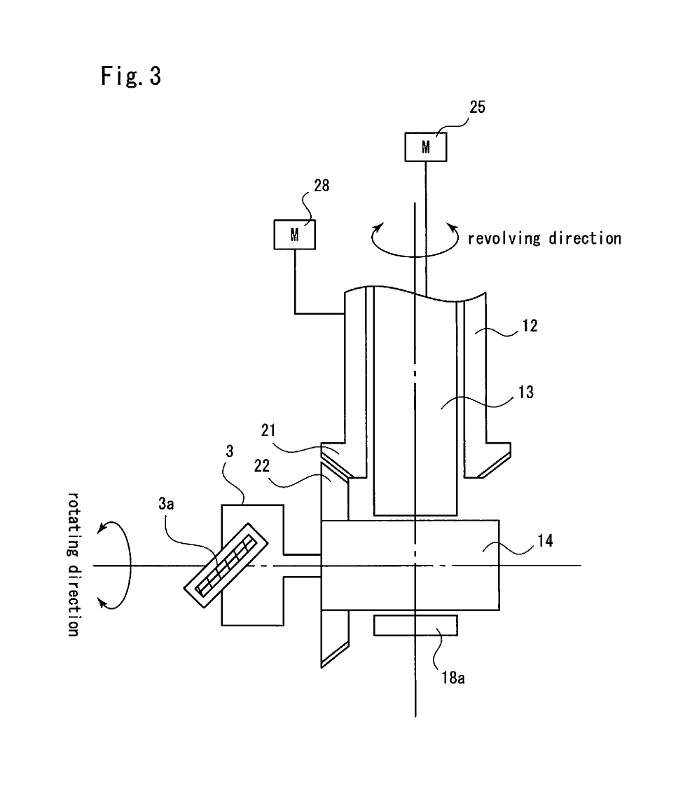

At this time, the nozzle 3 is constituted to be moved on a three-dimensional movement locus as illustrated in FIG. 3, whereby the entire inner surface 2A of the tank 2 can be washed.

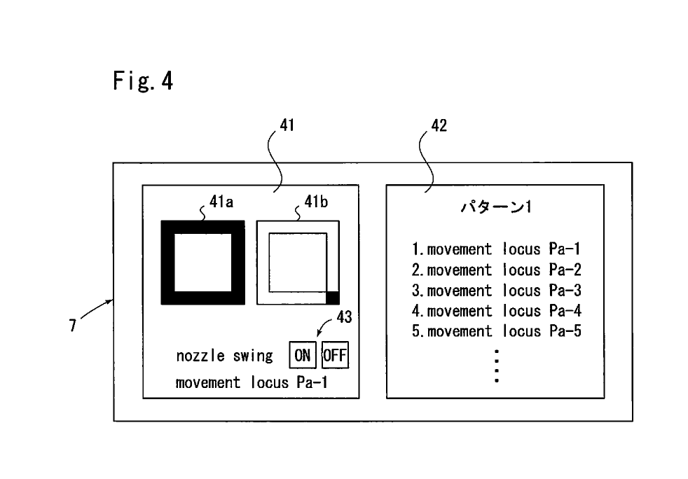

The movement locus of the nozzle 3 and a washing pattern combining a plurality of the movement loci of the nozzle 3 are registered in control means 6, and at that time, the worker can visually set the three-dimensional movement locus of the nozzle 3 by using a setting screen displayed on display means 7 illustrated in FIG. 4.

As illustrated in FIG. 1, the washing unit 4 includes a tubular support member 11 provided capable of elevation by the elevating mechanism 5, an outer tube 12 pivotally supported by the support member 11 rotatably, an inner tube 13 as a rotation shaft pivotally supported on an inner side of the outer tube 12 rotatably, and a turning shaft 14 disposed on a lower end portion of the inner tube 13 horizontally and pivotally supported rotatably, and the nozzle 3 is coupled with a distal end portion of the turning shaft 14.

The support member 11 is a tubular member fixed to the elevating mechanism 5 and provided in a vertical direction, a lid body 15 for closing an opening portion 2a of the tank 2 when the nozzle 3 is inserted into the tank 2 is provided on a lower part of the support member 11, and an annular stopper 15A for preventing liquid leakage and scattering is provided on an outer peripheral portion of the lid body 15 and an inward position close to that.

The outer tube 12 is pivotally supported inside the support member 11 through a bearing 16 and is capable of axial rotation in a horizontal direction in that state, while the inner tube 13 is pivotally supported inside the outer tube 12 rotatably through a bearing 17 and is capable of axial rotation in the horizontal direction in that state.

A box-shaped gear case 18 is provided on a lower part of the outer tube 12, capable of relative rotation in a circumferential direction with respect to the outer tube 12, and a distal end portion of the inner tube 13 protrudes into the gear case 18, and the turning shaft 14 and the like are accommodated therein.

A columnar support member 18a is disposed inside the gear case 18, a pair of bearings 19A and 19B is provided between a lower end portion of the inner tube 13 and an upper end of the support member 18a, and the turning shaft 14 is pivotally supported by the bearings 19A and 19B, capable of axial rotation.

A rotation axis of the turning shaft 14 is constituted to be directed to the horizontal, whereby the turning shaft 14 is capable of axial rotation in the vertical direction orthogonal to the rotating directions of the outer tube 12 and the inner tube 13.

A distal end of the turning shaft 14 protrudes to an outside of the gear case 18 in a state where liquid tightness is maintained by a seal member 18b, and a base portion of the nozzle 3 is coupled with the distal end portion in the orthogonal direction.

The nozzle 3 is a flat nozzle injecting the washing liquid widely, having an injection port 3A which is a distal end of the nozzle 3 with an elongated linear shape, and is provided such that a longitudinal direction of the injection port 3A is inclined by approximately 45° with respect to the horizontal direction as illustrated in FIG. 3. An angle of this injection port 3A in the longitudinal direction is not limited to 45° but can be changed manually or automatically as appropriate.

And according to the aforementioned constitution, the nozzle 3 of this embodiment is rotated in a horizontal plane around the inner tube 13 as the rotation shaft and is rotated in a substantially vertical plane around the turning shaft 14.

In the following description, the revolution of the nozzle 3 refers to rotation of the nozzle 3 in the horizontal plane around a rotation center of the inner tube 13 with the rotation of the inner tube 13, and the rotation of the nozzle 3 refers to rotation of the nozzle 3 in the vertical plane around the rotation center of the turning shaft 14 with the rotation of the turning shaft 14.

Subsequently, inside the gear case 18, a first bevel gear 21 as a sun gear is provided on a lower end portion of the outer tube 12, and a second bevel gear 22 meshed with the first bevel gear 21 is provided on an outer peripheral portion of the turning shaft 14.

Moreover, an upper end portion of the inner tube 13 protrudes above the outer tube 12, and a gear 23 is provided on the protruding portion. And a first motor 25 including a gear 24 meshed with the gear 23 is provided on the support member 11.

Furthermore, a gear 26 is mounted on a portion protruding above the support member 11 in the outer tube 12, and a second motor 28 including a gear 27 meshed with the gear 26 is provided on the support member 11.

In the aforementioned constitution, if only the first motor 25 is driven by the control means and the second motor 28 is not allowed to be driven, only the inner tube 13 is axially rotated through the gears 23 and 24, and the outer tube 12 is not axially rotated.

At this time, since the turning shaft 14 is pivotally supported at the distal end of the inner tube 13 through the bearings 19A and 19B, the turning shaft 14 is turned in the horizontal direction with the rotation of the inner tube 13, and as a result, the nozzle 3 is rotated in the revolving direction.

Moreover, since the turning shaft 14 is rotated in the vertical direction with the rotation of the inner tube 13 by meshing between the first bevel gear 21 and the second bevel gear 22, the nozzle 3 is rotated in the rotating direction.

On the other hand, if the first motor 25 is not driven by the control means 6 and only the second motor 28 is driven, only the outer tube 12 is axially rotated through the gears 26 and 27, and the inner tube 13 is not axially rotated.

As a result, since the inner tube 13 is not rotated, the turning shaft 14 is not turned in the horizontal plane and thus, the nozzle 3 is not rotated in the revolving direction. On the other hand, since the turning shaft 14 is rotated in the vertical direction by the meshing between the first bevel gear 21 of the outer tube 12 and the second bevel gear 22 of the turning shaft 14, the nozzle 3 is rotated in the rotating direction.

In this embodiment, the revolution and the rotation of the nozzle 3 by the first motor 25 is combined with the rotation of the nozzle 3 by the second motor 28 by individually controlling the first and second motors 25 and 28 by the control means 6 so that the nozzle 3 can be directed to an arbitrary direction.

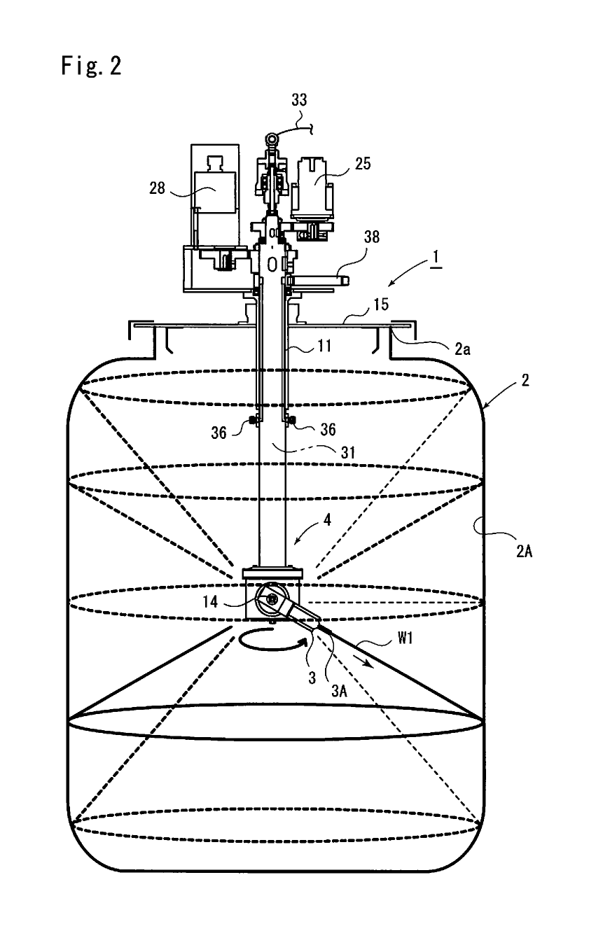

More specifically, as indicated by a solid line in FIG. 2, the nozzle 3 can be revolved while the rotation is stopped in a state where the nozzle 3 is inclined at a predetermined angle.

For that purpose, the inner tube 13 is operated at a required rotation speed by the first motor 25 so as to revolve the nozzle 3 at the distal end of the turning shaft 14, while the rotation of the turning shaft 14 for rotating the nozzle 3 is offset by operating the outer tube 12 at a required rotation speed by the second motor 28 so as to stop the rotation of the nozzle 3.

That is, by setting the rotation speeds of the first and second motors 25 and 28 in advance, a movement locus of the nozzle 3 can be set arbitrarily, and even the movement locus on which the nozzle 3 is made to swing in the rotating direction by a predetermined angle each while the nozzle 3 is rotated in the revolving direction can be set, for example.

A washing liquid passage 31 for supplying the washing liquid to the nozzle 3 is constituted by a liquid passage 13A formed inside the inner tube 13 and a liquid passage 14A formed in the turning shaft 14, and a first supply source 34 for supplying a first washing liquid W1 is connected to a connection tool 32 provided on an end portion of the liquid passage 13A through a conduit 33.

The first supply source 34 has an operation controlled by the control means 6, and the control means 6 allows the first washing liquid W1 to be supplied from the first supply source 34 to the washing liquid passage 31 through the conduit 33 when necessary.

Moreover, in this embodiment, a second washing liquid passage 35 which is a system separate from the washing liquid passage 31 is provided in the outer tube 12.

The second washing liquid passage 35 is constituted by an axial passage 12A formed inside the outer tube 12 formed thickly, an annular groove 12B provided on an upper end portion of the axial passage 12A and opened in an outer peripheral surface of the outer tube 12, and an injection port 36 provided on a lower end portion of the axial passage 12A and opened in the outer peripheral surface of the outer tube 12, and the injection port 36 is provided below the lid body 15.

The annular groove 12B is covered by an annular seal member 37, the annular seal member 37 is connected to a second supply source 39 supplying the second washing liquid W2 through a conduit 38, and the second supply source 39 has an operation controlled by the control means 6.

According to the aforementioned constitution, the inner surface 2A of the tank 2 can be preliminarily washed by the washing liquid or can be rinsed by injecting the second washing liquid W2 from the injection port 36 while the outer tube 12 is rotated by the second motor 28, separately from washing by the first washing liquid W1 using the nozzle 3.

As described above, in the washing device 1 of this embodiment, the movement locus of the nozzle 3 can be set arbitrarily by controlling the rotation speeds of the first and second motors 25 and 28, and such a movement locus of the nozzle 3 that a portion where stains can remain easily on the inner surface 2A of the tank 2 is washed with emphasis, for example, can be set.

However, since the movement locus of the nozzle 3 is determined by the rotation speeds of the first and second motors 25 and 28, it is difficult for the worker to image the three-dimensional movement locus of the nozzle 3 from such numeral values.

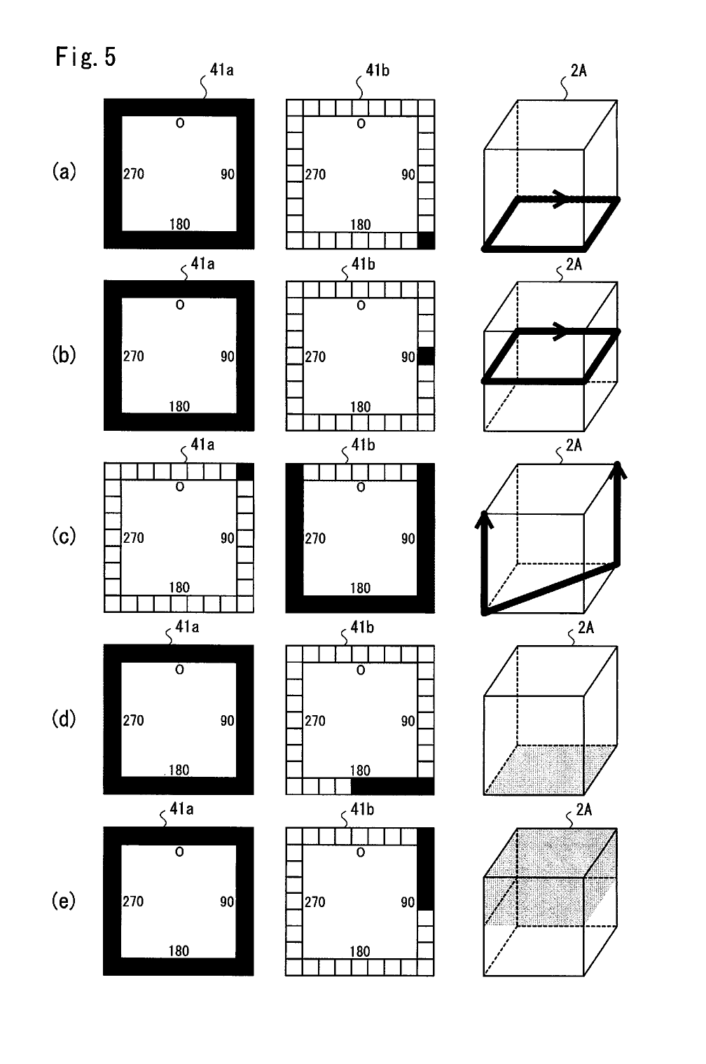

Thus, in this embodiment, visual imaging of the movement locus of the nozzle 3 for easy setting is made possible by using the setting method as illustrated in FIGS. 4 and 5.

FIG. 4 illustrates a setting screen of the movement locus of the nozzle 3, and the setting screen is displayed on the display means 7 connected to the control means 6 as illustrated in FIG. 1.

A movement locus setting portion 41 for setting the movement locus of the nozzle 3 and a work pattern setting portion 42 for preparing a work pattern combining the movement locus of the nozzle 3 set by the movement locus setting portion 41 along elapsed time of a work are displayed on the display means 7.

In this embodiment, the work pattern can be prepared and an operation from start to end of a washing work can be registered by combining a plurality of the movement loci of the nozzle 3 in accordance with the shapes and the like of the inner surface 2A of the tank 2 by registering a plurality of the movement loci of a plurality of types of the nozzle 3.

In the movement locus setting portion 41, a revolving direction model 41a as a first rotation model for setting rotation of the nozzle 3 in the revolving direction and a rotating direction model 41b as a second rotation model for setting the rotation of the nozzle 3 in the rotating direction are displayed.

Each of the revolving direction model 41a and the rotating direction model 41b is constituted by 32 pieces of annularly continuing frames, and 0, 90, 180, and 270 indicating the directions of the nozzle 3 are described correspondingly to a frame substantially at a center of each side constituting the square.

The angle of each frame in this embodiment is in a unit of 11.25°, but the unit size of the angle can be arbitrarily set such as the unit of 5° so as to have 72 pieces of frames.

Moreover, display of each frame can be switched to black or white by an instruction of the worker so that the nozzle 3 is directed to a direction corresponding to the frame switched to black in this embodiment, for example.

Hereinafter, an example of the setting of the movement locus of the nozzle 3 will be described by using FIGS. 5, and FIGS. 5(a) to 5(e) illustrate the revolving direction model 41a and the rotating direction model 41b in which required frames are switched to black, respectively, and a locus of a washing position by the washing liquid injected to the inner surface 2A of the tank 2 injected from the nozzle 3.

Here, the setting method when the tank 2 having the inner surface 2A with a substantially cuboid shape without a top surface is to be washed is described, and in this case, the washing unit 4 is positioned by the elevating mechanism 5 so that the center of the nozzle 3 in the revolving direction and in the rotating direction comes to substantially the center position of the tank 2.

FIG. 5(a) illustrates the setting screen of the movement locus of the nozzle 3 when an entire periphery of corner parts which are boundary portions between the bottom surface and the side surfaces of the tank 2 is to be washed.

In this case, for the revolving direction model 41a, all the frames of the revolving direction model 41a are switched to black so that the nozzle 3 is rotated by 360° in the revolving direction, while for the rotating direction model 41b, only the frame of 135 (or 225) is switched to black so that the nozzle 3 is directed diagonally downward by 45°.

By setting as above, the movement locus of the nozzle 3 is held so as not to be rotated in the state where the nozzle 3 is directed diagonally downward by 45°, and the nozzle 3 is revolved in the horizontal direction in that state, and the entire periphery of the corner parts between the bottom surface and the side surfaces is washed by the washing liquid injected from the nozzle 3.

FIG. 5(b) illustrates the setting screen of the movement locus of the nozzle 3 when a portion at the same height as a mounting height of the nozzle 3 on the side surfaces of the tank 2 is to be annularly washed.

In this case, for the revolving direction model 41a, all the frames of the revolving direction model 41a are switched to black so that the nozzle 3 is rotated by 360° in the revolving direction, while for the rotating direction model 41b, only the frame of 90 (or 270) is switched to black so that the nozzle 3 is directed to the horizontal.

By setting as above, the movement locus of the nozzle 3 is held so as not to be rotated in the state where the nozzle 3 is directed to the horizontal, and the nozzle 3 is revolved in the horizontal direction in that state, and the entire periphery of substantially the center parts of the side surfaces is washed by the washing liquid injected from the nozzle 3.

FIG. 5(c) illustrates the setting screen of the movement locus of the nozzle 3 when corner parts which are boundary portions between the side surface and the side surface located diagonally in the tank 2 are to be washed, and the nozzle 3 passes diagonally across the bottom surface at the time.

In this case, for the revolving direction model 41a, only the frame 45 (or 135) is switched to black, while for the rotating direction model 41b, the frames in a range from 45 to 315 are switched to black so that the nozzle 3 is directed to the side surface and the bottom surface of the tank 2.

By setting as above, the movement locus of the nozzle 3 is not revolved but is only rotated starting in the state where the nozzle 3 is directed toward an upper end portion of the corner part at the position of 45° with respect to the nozzle 3.

As a result, the washing liquid is injected from the nozzle 3 from an upper end portion to a lower end portion of one of corner parts, and when the nozzle 3 passes diagonally across the bottom surface after that, the washing liquid is injected from the lower end portion to the upper end portion of the other corner part located diagonally. At that time, the washing liquid is not injected to the opening portion 2a on the upper surface of the tank 2.

FIG. 5(d) illustrates the setting screen of the movement locus of the nozzle 3 when the entire bottom surface of the tank 2 is to be washed.

In this case, all the frames of the revolving direction model 41a are switched to black, while for the rotating direction model 41b, only the frames from 135 to 180 (or 180 to 225) are switched to black so that the nozzle 3 is directed from diagonally below by 45° to immediately below.

By setting as above, the movement locus of the nozzle 3 becomes such that the nozzle 3 is revolved by 360° in the revolving direction while the nozzle 3 swings in the rotating direction within a range from diagonally below by 45° to immediately below.

When such movement locus is set, the nozzle 3 is preferably made to go around a plural number of times in the revolving direction, and at that time, the control means 6 can be so configured that the washing liquid is injected uniformly to the bottom surface of the tank 2 by automatically setting a swing cycle in the rotating direction so that the movement loci of the nozzle are not overlapped.

FIG. 5(e) illustrates the setting screen of the movement locus of the nozzle 3 when an upper half of the side surfaces of the tank 2 is to be washed.

In this case, all the frames of the revolving direction model 41a are switched to black, while for the rotating direction model 41b, only the frames from 45 to 90 (or 270 to 315) are switched to black so that the nozzle 3 is directed from diagonally above by 45° to the horizontal.

By setting as above, the movement locus of the nozzle 3 becomes such that the nozzle 3 is revolved by 360° in the revolving direction while the nozzle 3 swings in the rotating direction within a range from diagonally above by 45° to the horizontal. In this case, the washing liquid is not injected to the top surface of the tank 2.

When such movement locus is set, too, the nozzle 3 is preferably made to go around a plural number of times in the revolving direction so that the washing liquid is injected uniformly to the side surface of the tank 2.

As described above, the movement locus of the nozzle 3 can be set by setting the direction of the nozzle 3 in each of the revolving direction model 41a and the rotating direction model 41b in the movement locus setting portion 41.

Moreover, in the movement locus setting portion 41, the setting of causing the nozzle 3 to swing can be made while the nozzle 3 is moved along the set movement locus of the nozzle 3, and the setting can be made by selecting a swing operation setting button 43 displayed on the display means 7.

More specifically, in the case of the setting of the movement locus for revolving the nozzle 3 in the horizontal direction while the nozzle 3 is held at a predetermined angle as in FIG. 5(a), for example, the nozzle 3 swings vertically within a range of the predetermined angles while revolving in the horizontal direction, whereby washing in a wide range can be performed. The range of the swing at this time can be set arbitrarily.

When the movement locus of the nozzle 3 is set as above, the control means 6 automatically calculates rotation speeds of the first and second motors 25 and 28 so that the nozzle 3 is moved in accordance with the set movement locus of the nozzle 3.

The movement locus of the nozzle 3 set as above and the rotation speeds of the first and second motors 25 and 28 for that are stored with an ID set for each set movement locus of the nozzle 3.

Subsequently, in the work pattern setting portion 42, the work pattern from start of washing to end of the washing is set by combining a plurality of movement loci of the nozzle 3 set in the movement locus setting portion 41.

More specifically, the ID of the movement locus of the nozzle 3 set in the movement locus setting portion 41 is read out, washing time and a washing cycle in each movement locus is input, and the IDs are arranged in a time series so as to set the work pattern.

First, a work pattern combining a movement locus Pa-1 for which 135 is set, a movement locus Pa-2 for which 146.25 is set, a movement locus Pa-3 for which 157.5 is set, a movement locus Pa-4 for which 168.75 is set, and a movement locus Pa-5 for which 180 is set in the rotating direction model 41b illustrated in FIG. 5(a) is prepared, for example.

According to this work pattern, the first washing liquid W1 injected from the nozzle 3 is injected to the bottom surface of the tank 2 while the ring-shaped movement locus gradually reduces its diameter concentrically, whereby the entire bottom surface of the tank 2 can be washed.

At this time, the washing liquid only needs to be injected repetitiously for a portion where stain cannot be removed easily such as a corner part of the tank 2, for example, or more specifically, the movement locus Pa-1 for which 135 is set in the rotating direction model 41b only needs to be set a plurality of times repetitiously for the work pattern.

Moreover, for the movement loci of the nozzle 3 set so that the washing liquid is injected in a planar state as in FIGS. 5(d) and 5(e), the work pattern can be prepared by combining them.

As described above, according to this embodiment, the nozzle 3 can be revolved and rotated by the first and second motors 25 and 28, and since the movement locus of the nozzle 3 can be set by using the aforementioned revolving direction model 41a and the rotating direction model 41b, the movement locus of the nozzle 3 can be set while visually imaging it without being conscious about the parameters such as the rotation speeds for operating the first and second motors 25 and 28.

Moreover, since the work pattern can be prepared by combining a plurality of movement loci of the nozzle 3 by using the work pattern setting portion 24, various work patterns can be prepared in accordance with the shape of the tank 2 and a portion which is easily stained.

In the aforementioned embodiment, a plurality of black and white frames aligned annularly are used for the revolving direction model 41a and the rotating direction model 41b, but the aforementioned constitution is not limiting as long as the angle of the nozzle 3 can be visually set.

Moreover, the images or video illustrating the shape of the inner surface 2A of the tank 2 or the washing position of the washing liquid as illustrated in FIG. 5 may be displayed on the display means 7 together with the revolving direction model 41a and the rotating direction model 41b in the movement locus setting portion 41.

Furthermore, in the case of the tank 2 having a substantially cuboid shape as in the embodiment, the revolving direction model 41a and the rotating direction model 41b are matched with a sectional shape of the tank 2, and the frame portions only need to be aligned in a shape of a square in accordance with the sectional shape of the tank 2 as illustrated in FIGS. 5, but in the case of the columnar tank 2, the frame portions of the revolving direction model 41a can be aligned substantially in a shape of a circle in accordance with the sectional shape.

Moreover, when 45° is set in the rotating direction model 41b in the aforementioned embodiment, the nozzle 3 is controlled by the control means 6 so as to be directed diagonally upward, but on the other hand, it may be so configured that the distal end of the nozzle 3 is directed to the corner part of the boundary portion between the top surface and the side surface of the tank 2.

In that case, it is only necessary to change a pitch of the angle at which the nozzle 3 set for each frame is actually directed in accordance with the height of the tank 2 for the frames set as 45 to 135 between the upper corner part and the lower corner part.

Moreover, in the aforementioned embodiment, the second washing liquid passage 35 is provided in the outer tube 12 so that the washing liquid is injected from the supply source, but they may be omitted, and the tank 2 may be washed only with the first washing liquid W1 from the nozzle 3.

Moreover, the aforementioned embodiment is constituted such that the nozzle 3 is inserted into the tank 2 from above, and the nozzle 3 is revolved and rotated in that state, but the nozzle 3 may be inserted into the object to be washed from the side or from below the object to be washed for washing in accordance with the shape of the object to be washed, and in the case of washing by moving the nozzle 3 three-dimensionally, the object to be washed does not necessarily have to have the internal space as the tank.

### REFERENCE SIGNS LIST

1 washing device

2 tank (object to be washed)

3 nozzle

6 control means

7 display means

12 outer tube

13 inner tube (rotation shaft)

14 turning shaft

21 first bevel gear

22 second bevel gear

25 first motor

28 second motor,

41 movement locus setting portion

41a revolving direction model

41b rotating direction model

42 work pattern setting portion

What is claimed is:

1. An operation setting method of a washing device including a rotation shaft having a washing liquid passage provided therein and pivotally supported rotatably, a turning shaft provided in a direction substantially orthogonal to the rotation shaft and pivotally supported rotatably at a distal end of the rotation shaft, a nozzle provided on the turning shaft and injecting the washing liquid, a first motor and a second motor for rotating the rotation shaft and the turning shaft so as to rotate the nozzle around the rotation shaft and the turning shaft, and control means for controlling movement of the nozzle by controlling the first motor and the second motor, respectively, characterized by comprising steps of:
displaying a first rotation model for setting an operation of the nozzle around the rotation shaft and a second rotation model for setting the operation of the nozzle around the turning shaft;
setting the operation of the nozzle around the rotation shaft and the operation of the nozzle around the turning shaft by using the displayed first rotation model and second rotation model, respectively; and
preparing a movement locus of the nozzle from the set operation of the nozzle around the rotation shaft and operation of the nozzle around the turning shaft.

2. The operation setting method of a washing device according to claim 1, characterized in that
a washing pattern for washing an object to be washed is prepared by combining a plurality of prepared movement loci of the nozzle.

3. A washing device including a rotation shaft having a washing liquid passage provided therein and pivotally supported rotatably, a turning shaft provided in a direction substantially orthogonal to the rotation shaft and pivotally supported rotatably at a distal end of the rotation shaft, a nozzle provided on the turning shaft and injecting the washing liquid, a first motor and a second motor for rotating the rotation shaft and the turning shaft so as to rotate the nozzle around the rotation shaft and the turning shaft, and control means for controlling movement of the nozzle by controlling the first motor and the second motor, respectively, comprising:
display means for displaying a first rotation model for setting an operation of the nozzle around the rotation shaft and a second rotation model for setting the operation of the nozzle around the turning shaft, characterized in that
a movement locus of the nozzle is set on the basis of the operation of the nozzle around the rotation shaft and the operation of the nozzle around the turning shaft set by the first rotation model and the second rotation model.

4. The washing device according to claim 3, characterized in that
the display means includes a washing pattern preparing portion for preparing a washing pattern for washing an object to be washed, and the washing pattern is prepared by combining a plurality of movement locus in the washing pattern preparing portion.
